(19) United States
(12) Patent Application Publication
(10) Pub. No.: US 2012/0187691 A1
(43) Pub. Date: Jul. 26, 2012

(54) Source of electric green-energy extracted at the maximum potential point from discharged wastewater of residential and commercial buildings

(76) Inventors: Yasser R. Shaban, Solia (BG); Milen K. Panteleev, Concord, CA (US)

(21) Appl. No.: 13/012,820

(22) Filed: Jan. 25, 2011

(51) Int. Cl. F03B 13/00

(52) U.S. Cl. 290/54

(57) ABSTRACT

The potential energy of wastewater is considered as source of electric green energy in the present invention. The total potential energy, spontaneous and stimulated, of wastewater discharged from residential and business buildings are collected at the maximum point before leaving the buildings. Hence the conversion of the potential energy of wastewater in each building into electricity via electromagnetic induction or hydroelectric generator is more valuable in this case.

### BACKGROUND

One type of previous works on energy recovery from wastewater was focused on heat recovery from discharged hot wastewater, which is a different mechanism and system than the present invention. Previous works include a household heat recovery device which absorbs residual heat from the water flowing down the drain of household shower or bathtub unit. These techniques devise a device that must be attached at each bathtub unit in the whole building, and that adds additional cost to the recovery's purpose. For example; U.S. Pat. No. 7,849,530 issued to Hendricks on Dec. 14, 2010.

Other type of previous works on energy recovery from wastewater was focused on collecting the “kinetic energy” of the discharged wastewater from the main pipeline of the community sewer system. Such idea lies away from the goal of the present invention since such wastewater lost its whole potential energy; i.e. height. On the other hand, the discharged wastewater is not collecting at each building and hence it lost most of the kinetic energy when it gathered from all pipelines (fosses due to angles, elbows. etc.) of the main community sewer system. For example: U.S. patent publication number 2007/0212213A filed by David Bolyard.

The present invention relates to the direct conversion of the spontaneous and stimulated potential energy of the discharged wastewater at the maximum potential point of the residential and commercial buildings into electricity via hydroelectric generator (electromagnetic induction). The hydroelectric generator is oriented at the lowest point of the pipeline (maximum potential point) of the wastewater at each building.

Domestic wastewaters consist primarily of liquid discharges resulting from bathing, laundering and cooking activities as well as from rainfall. Wastewater comprises liquid waste discharged by domestic residences and commercial buildings.

Wastewater being discharged from heights above the sea level has a potential energy that can be converted into useful type of electric energy. The average wastedwater¹ per capita or person in USA is 578 liters per day (0.578 m³/day) and in Europe is more-or-less 300 liters per day (0.3 m³/day), but it varies from season to season. If we consider the city of New York² of populations 8,363,710, then the total electric. power (spontaneous portion) that would be extracted from discharged wastewater is 0.36 MWe/m (per meter height). The extracted electric power per building would be available during day and night and it increases during the rain time since the discharge tubes of buildings dispose the water from rains as well.

The present invention reveals the applicable use of the total potential energy (spontaneous and stimulated) of the discharged wastewater from residential and commercial buildings as a source of electric. green-energy. The efforts of the invention perimeterialize the first use of the maximum potential energy (spontaneous and stimulated) of the discharged wastewater from buildings that can he used directly or stored for later uses.

### BRIEF DESCRIPTION OF THE INVENTION

The main embodiment of the present patent includes the realization of the potential use or the spontaneous (free falling) and stimulated potential energy (chemically, thermally, overhead pressure) of the discharged wastewater from residential and commercial buildings is through a hydroelectric generator. The conversion Of the potential energy of both types into electricity is performed at the maximum potential point i.e. before leaving the buildings.

All types of wastewater are collected from these buildings and transported in pipelines for treatment or disposed underground or converted into electric energy in some cases. As we realize that, wastewater is discharged from high level and thus it carries potential energy. The potential energy can be converted into electric energy via hydroelectric generator placed at the lowest point of pipeline (maximum potential point) of each building i.e. before the exit of the pipeline. The generated electricity can be utilized instantaneously each building, or integrated with the main green electric grid, or stored for later uses.

### BRIEF DESCRIPTION OF THE DRAWING

FIG. 1 is an illustration of converting the potential energy of the dissipated wastewater.

### DETAILED DESCRIPTION

The total energy is the sum of the potential and kinetic energies. The potential energy of a flow is considered spontaneous when it has no other components than the free falling. However, the potential energy of flow is stimulated when it is accelerated above the free falling value. The stimulation can he caused by chemical reactions or by thermal heating, or by overhead pressure at the upper stream. In both cases, the total potential energy is the sum of the spontaneous and stimulated energies.

The spontaneous potential power Pₚ of free falling water in frictionless tube from height h can be found from the following equation:

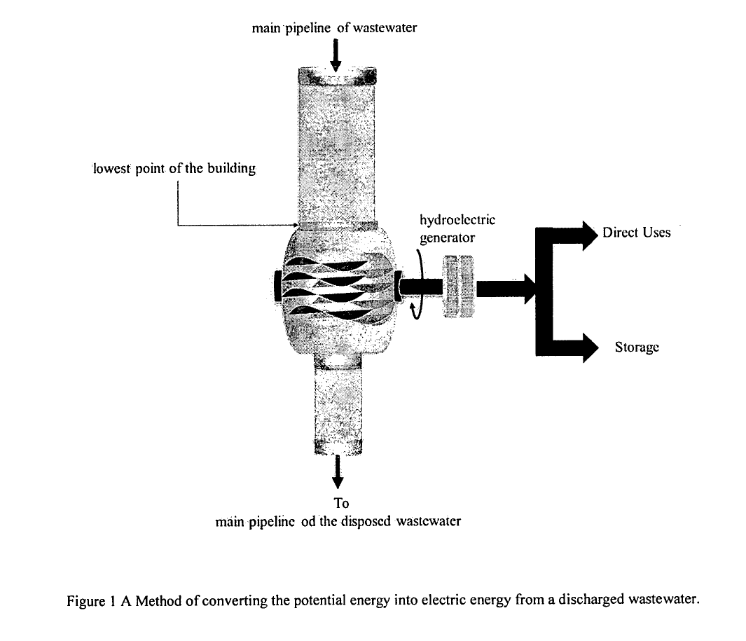

P_{ρ}=ρ h g Q. (1)

Where ρ is the density of water (=1000 kg/m³). h is the height at which the water falls in meters, g is the acceleration constant (=9.81 m/s²), and Q is the water flow rate in m³/sec. (The density of the wastewater is a little greater than 10³ kg/m³ since it comprises soluble and soluble chemical elements.) The wastewater discharged from apartments is collected in one or more tubes depending on the design of the building. Direct conversion of the potential energy of the wastewater into mechanical energy can be performed by a hydro-turbine (a part of hydroelectric generator), FIG. 1, which is placed at the lowest point of the wastewater tube. At this point the potential energy is the highest, and thus, it is the maximum potential point. The potential energy of the free falling wastewater can be converted into mechanical energy with efficiency greater than 90% with modern hydro-turbine. Subsequently, the mechanical energy can be converted into electricity via electromagnetic induction with efficiency reaching 60-70% with powerful magnets. So the overall efficiency of the conversion process of modern hydroelectric generator is 54 to 63%.

In order to determine the amount of electric power that can be generated from the wastewater, we give the following example. Consider the mean height (the actual height is 40 meters) of a building is 20 meters, Such building is composed of 50 apartments and each apartment includes 4 persons. Knowing that, the average dissipated wastewater (0.578 m³/day/person) is 1.15 m³ per day in USA. Then, the rate of water flow Q is 1.3×10⁻³ m³/s. Substitute the appropriate values into Equation 1 we conclude that the available electric power (free flitting only) is 262 W.

The stimulated potential energy of the discharged wastewater has the form of kinetic energy. The kinetic term of the discharged wastewater contributes more or less than the spontaneous power given by Equation 1, and this depends on the conditions of the water flow. The kinetic water-flow increases when the discharged wastewater is forced to accelerate above the limit of free falling velocity (or acceleration constant g) via chemical stimulants, thermal agents (e.g. solar heat), or when the upper stream of the water flow has an overhead pressure greater than the lower stream. All these factors contribute to the increase of the velocity of the falling flow. The stimulated potential power (the kinetic power) Pₖ (watt) in all cases is given by:

Pₖ=½ ρ A V³. (2)

Where ρ, A, and V are the density of the discharged water in kg/m³, the cross sectional area of the pipe in m², and the velocity of the water flow in m/s, respectively. Water is incompressible flow and thus when it is heated or subject to heat its density ρ remains constant as long as it is a single phase.

The thermal effect on the water flow is through the change of its viscosity. The viscosity of the water drops with the increase of temperature. The reduction of the water viscosity leads to an increase of water flow i.e. water velocity. In this case, the total electric power extracted from discharged wastewater is the sum of Equations 1 and 2.

The chemical stimulation on the water flow is through changing its ionic species. The increase of the ionic species of the water flow leads to an increase of its velocity. In this case, the total electric power extracted from discharged wastewater is the sum of Equations 1 and 2.

The velocity of the water flow increases when the overhead pressure of its upper stream is greater than the pressure at its lower stream. In this case, the total electric power extracted from discharged wastewater is the sum of Equations 1 and 2.

The extracted electric power from wastewater can be used directly inside buildings as a source of electricity or integrated in the green energy grid, photovoltaic, or it can he stored in one of the energy storage systems⁴⁻⁶ for later uses.

### REFERENCES

¹ http://info.k4health.org/pr/m14/m14chap2_{—}2.shtml.

² http://www.census.gov/population/www/socdemo/compraceho.html, 2008 Population Estimates. U.S. Census Bureau, Population Division. 2009 Jul. 01.

³ Acheson, D. J. “Elementary fluid dynamics”, Clarendon Press, Oxford (1990).

⁴ K. LaCommare and J. Eto, Lawrence Berkeley National Laboratory Report no. LBNL-55718, Understanding the Cost of Power Interruptions to U.S. Electricity Consumers, Sept. 2004.

⁵ Energy Storage Benefits and Market Analysis Handbook, James M. Eyer, Joseph J. Iannucci, and Garth P.

⁶ Corey, Sandia National Laboratory Report no. SAND2004-6177 (December 2004).

What is claimed is:

1. A method, comprising: a system of converting the spontaneous and stimulated potential energies of the discharged wastewater at the maximum potential point of the residential and commercial buildings (before leaving the building) into electricity.

2. The method of claim 1, further comprising a method of reducing the viscosity of the discharged wastewater in order to extract the electric energy at the maximum potential point.

3. The method of claim 1, further comprising a method of applying chemical and thermal agents to the discharged wastewater.
